(19) United States
(12) Patent Application Publication
(10) Pub. No.: US 2012/0172038 A1
(43) Pub. Date: Jul. 5, 2012

(54) METHOD FOR CONFIGURATION CELL BY MULTI MODE TERMINAL AND METHOD FOR OPTIMIZATION CELL BY MULTI MODE TERMINAL

(75) Inventors: Sung Kyung Kim, Daejeon (KR); Eunkyung Kim, Daejeon (KR); Sung Cheol Chang, Daejeon (KR); Hyun Lee, Daejeon (KR); Chul Sik Yoon, Seoul (KR)

(73) Assignee: ELECTRONICS AND TELECOMMUNICATION RESEARCH INSTITUTE, Daejeon (KR)

(21) Appl. No.: 13/338,219

(22) Filed: Dec. 27, 2011

(30) Foreign Application Priority Data
Dec. 27, 2010 (KR) 10-2010-0135132
Dec. 27, 2010 (KR) 10-2010-0135133
Mar. 2, 2011 (KR) 10-2011-0018498
Mar. 2, 2011 (KR) 10-2011-0018499
Dec. 26, 2011 (KR) 10-2011-0142080
Dec. 26, 2011 (KR) 10-2011-0142081

(51) Int. Cl. H04W 4/00; H04W 52/04; H04W 72/04

(52) U.S. Cl. 455/434

(57) ABSTRACT

A method of configuring a cell of a terminal includes: transmitting, by the terminal, when the terminal searches for an idle band, a downlink frame; performing a network entry procedure with other terminals at 1 hop from the terminal; and optimizing, by the terminal, transmission power.

### CROSS-REFERENCE TO RELATED APPLICATION

This application claims priority to and the benefit of Korean Patent Application No. 10-2010-0135132, No. 10-2010-0135133, No. 10-2011-0018498, No. 10-2011-0018499, No. 10-2011-0142080, and No. 10-2011-0142081 filed in the Korean Intellectual Property Office on Dec. 27, 2010, Dec. 27, 2010, Mar. 2, 2011, Mar. 2, 2011, Dec. 26, 2011, and Dec. 26, 2011, respectively, the entire contents of which are incorporated herein by reference.

### BACKGROUND OF THE INVENTION

(a) Field of the Invention

The present invention relates to a method of configuration and optimizing a cell by a multimode terminal.

(b) Description of the Related Art

When a disaster or a calamity occurs, important society-based facilities may be broken or damaged. In society-based facilities, various communication facilities such as a wireless phone, a wired phone, and an Internet network are important infrastructure facilities, and when such a communication facility is broken or damaged, society is further confused in a disaster or calamity situation and restoration of a society may be lowered. Therefore, in such a case, it is important to provide a means to quickly restore or to replace a communication facility.

A base station in communication facilities is a central facility that performs a communication operation and receives data from a terminal or transfers data to a terminal. When a calamity or a disaster occurs, if such a base station is damaged, it is an important element for communication restoration to provide a means that can replace a function of the base station.

### SUMMARY OF THE INVENTION

The present invention has been made in an effort to provide a method of configuring a cell in a multimode terminal having advantages of performing a communication operation as a terminal performs a function of a base station in a communication system and configures a cell. The present invention has been made in an effort to further provide a method of configuring and optimizing a cell in a multimode terminal having advantages of performing a smooth communication operation as a terminal performs a function of a base station in a communication system and configures and optimizes a cell.

An exemplary embodiment of the present invention provides a method of configuring a cell of a terminal, the method including: transmitting, by the terminal, if the terminal finds an idle band, a downlink frame; performing a network entry procedure with other terminals at 1 hop from the terminal; and optimizing, by the terminal, transmission power.

The idle band may be determined as idle when the idle band does not exceed a received signal strength indication (RSSI) threshold.

The terminal may be a multimode terminal that can operate as a base station or a relay station.

Another embodiment of the present invention provides a method of configuring a cell of a terminal, the method including: searching for, by a first terminal, a band and periodically broadcasting, if the band is determined as idle, a preamble; receiving a collision report message from a second terminal having received the preamble; and recognizing, by the first terminal, the band as a confusion state and searching for another band.

The second terminal may be positioned at 1 hop from the first terminal. Yet another embodiment of the present invention provides a method of configuring a cell of a terminal, the method including: searching for, by a first terminal, a band and periodically broadcasting, if the band is determined as idle, a preamble; transmitting, if the first terminal does not receive a collision report message from another terminal, a downlink frame to a second terminal; allocating an uplink resource for a third terminal to the second terminal; receiving a collision report message of the third terminal from the second terminal; and recognizing, by the first terminal, the band as a confusion state and searching for another band.

Yet another embodiment of the present invention provides a method of configuring a cell of a terminal, the method including: searching for, by a first terminal, a band and periodically broadcasting, if the band is determined as idle, a preamble; transmitting, if the first terminal does not receive a collision report message from another terminal, a downlink frame to a second terminal; allocating an uplink resource for a third terminal to the second terminal; and performing, if a collision report message of the third terminal is not received from the second terminal for a predetermined time period, a network entry procedure with the second terminal or the third terminal.

The method may further include determining, when a network entry procedure is performed, a relay terminal based on a received ranging code.

The second terminal may be positioned at 1 hop from the first terminal, and the third terminal may be positioned at 2 hops from the first terminal.

Yet another embodiment of the present invention provides a method of optimizing a cell by a multimode terminal, the method including: broadcasting, by a first terminal, a scanning broadcasting message to a second terminal; broadcasting, by the first terminal, a link response message to the second terminal; and performing, by a terminal having a highest role grade of a base station, a function of the base station according to a request of the base station.

The scanning broadcasting message may include power capability of the first terminal.

The scanning broadcasting message may include a battery level of the first terminal.

The link response message may include a base station role grade of the first terminal.

Yet another embodiment of the present invention provides a method of optimizing a cell by a multimode terminal, the method including: broadcasting, by the multimode terminal that is operated in a base station mode, a dynamic link test request message including a candidate terminal list to another terminal; receiving a link test sequence (LTS) from the other terminal according to the order of the candidate terminal list; and requesting, by the multimode terminal, if a change of a base station mode operation terminal is necessary, a base station mode change to the selected terminal.

The dynamic link test request message may include transmission power information of the LTS.

The method may further include inducing, by the multimode terminal, handover to the selected terminal to another terminal.

### BRIEF DESCRIPTION OF THE DRAWINGS

FIG. 1 is a diagram illustrating an example of a cell that is formed by a method of configuring a cell according to an exemplary embodiment of the present invention.

FIG. 2 is a flowchart illustrating a method of configuring a cell of a terminal according to an exemplary embodiment of the present invention.

FIG. 3 is a diagram illustrating a cell that is formed according to an exemplary embodiment of the present invention.

FIG. 4 is a flowchart illustrating a method of configuring a cell according to another exemplary embodiment of the present invention.

FIG. 5 is a diagram illustrating an example of an optimized cell by a method of optimizing a cell according to another exemplary embodiment of the present invention.

FIG. 6 is a flowchart illustrating a method of optimizing a cell according to another exemplary embodiment of the present invention.

FIG. 7 is a diagram illustrating a method of configuring a cell according to another exemplary embodiment of the present invention.

FIG. 8 is a diagram illustrating a link test procedure of a candidate terminal according to another exemplary embodiment of the present invention.

FIG. 9 is a diagram illustrating a method of converting a base station mode function according to another exemplary embodiment of the present invention.

### DETAILED DESCRIPTION OF THE EMBODIMENTS

In the following detailed description, only certain exemplary embodiments of the present invention have been shown and described, simply by way of illustration. As those skilled in the art would realize, the described embodiments may be modified in various different ways, all without departing from the spirit or scope of the present invention. Accordingly, the drawings and description are to be regarded as illustrative in nature and not restrictive. Like reference numerals designate like elements throughout the specification.

In the entire specification, a mobile station (MS) may indicate a terminal, a mobile terminal (MT), a subscriber station (SS), a portable subscriber station (PSS), an access terminal (AT), and user equipment (UE), and may include an entire function or a partial function of the terminal, the MT, the SS, the PSS, the AT, and the UE.

Further, a base station (BS) may indicate a node B, an evolved node B (eNode B), an access point (AP), a radio access station (RAS), a base transceiver station (BTS), and a mobile multihop relay (MMR)-BS, and may include an entire function or a partial function of the node B, the eNode B, the AP, the RAS, the BTS, and the MMR-BS.

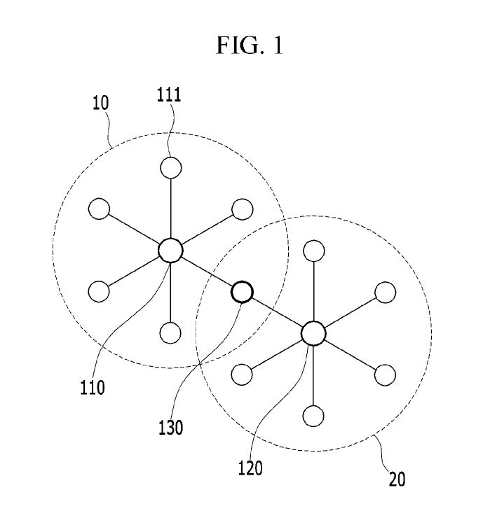

FIG. 1 is a diagram illustrating an example of a cell that is formed by a method of configuring a cell according to an exemplary embodiment of the present invention. In FIG. 1, a terminal is a multimode terminal that can operate as a BS or a relay station according to a case.

Referring to FIG. 1, the cell that is configured by the method of configuring a cell includes a plurality of terminals, and two terminals 110 and 120 thereof may each operate as a temporary BS. A temporary BS 110 has a communication radius 10, and the temporary BS 120 has a communication radius 20. The temporary BSs 110 and 120 each use a different frequency, and respective neighbor terminals 111 and 112 of the temporary BSs 110 and 120 exist, and each terminal transmits/receives data with 1-hop communication with the temporary BSs 110 and 120.

A network in which a direct link is formed can perform central control, and for effective high-rate data transmission and quality of service (QoS) control, a network is formed according to a role change of a multi-mode terminal.

Only one of the terminals 110 and 120 may function as a BS, and the terminals 110 and 120 may use the same frequency. In this case, a terminal 130 existing between the terminals 110 and 120 supports multihop relay between the terminals 110 and 120 and performs a function of an intermediate relay station.

Further, only one of the terminals 110 and 120 may function as a BS, and the terminals 110 and 120 may use different frequencies. In this case, the terminal 130 supports multihop relay between the terminals 110 and 120 and performs a function of an intermediate relay station.

Further, the two terminals 110 and 120 may each operate as a temporary BS, and the temporary BSs 110 and 120 may each use different frequencies and form a sharing relay link through the terminal 130 with a separate frequency. Further, the two terminals 110 and 120 may each operate as a temporary BS, and the temporary BSs 110 and 120 may each use the same frequency and form a sharing relay link through the terminal 130 with a separate frequency.

A cell that is configured in this way has a relatively small cell size. That is, communication terminals are condensed at the center, compared with cell coverage. Further, there is no hidden node problem, there is no shadowing for a specific link, and quality of each link is similar.

The terminal 110 is a multimode terminal that attempts to form a PMP communication network for operation of a BS function in an environment in which a BS communication network does not exist.

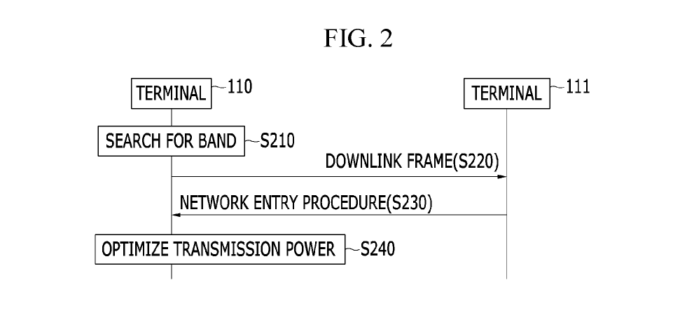

Hereinafter, a method of configuring the same cell as that of FIG. 1 will be described in detail with reference to FIG. 2.

FIG. 2 is a flowchart illustrating a method of configuring a cell of a terminal according to an exemplary embodiment of the present invention.

After the terminal 110 first searches for a band, the terminal 110 determines whether the band is idle (S210). If the band is idle, the terminal 110 transmits a downlink frame including a preamble to a terminal 111 (S220). In this case, after sequentially scanning a previously input band list, when the band does not exceed a defined RSSI threshold, the band is determined as idle. The terminal 110 continues a scan until an idle band is found. A secondary advanced preamble (SA-preamble) sequence index of preambles may represent a cell by a multimode terminal. In this case, the terminal 110 broadcasts a broadcasting message, map information, and uplink configuration information. Initial transmission power is determined based on channel modeling and a target cell radius.

Thereafter, other terminals in a 1-hop relationship with the terminal 110 perform a network entry procedure with the terminal 110 (S230). In this case, a procedure with a network that is performed after ranging and basic function negotiation, for example, authentication and encryption key management, and a registration procedure may be omitted or simplified.

Thereafter, the terminal 110 optimizes transmission power (S240). When a network entry procedure with terminals to communicate is complete, by measuring a channel state with each terminal, transmission power is optimized.

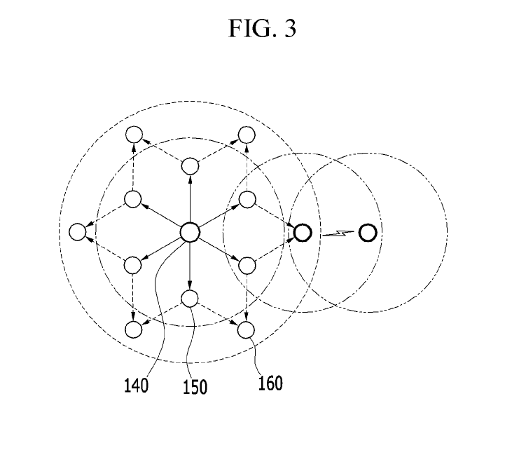

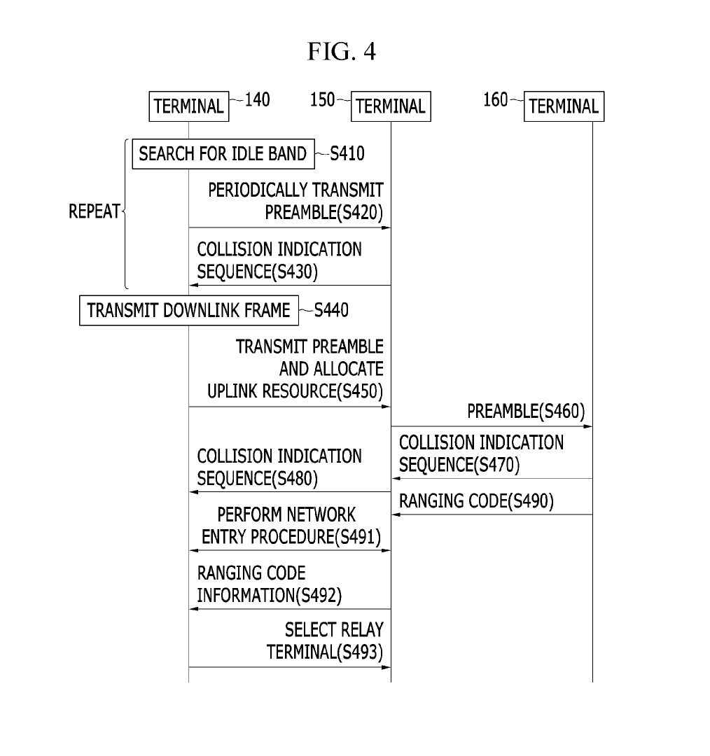

Hereinafter, a method of configuring a cell according to another exemplary embodiment of the present invention will be described with reference to FIGS. 3 and 4.

FIG. 3 is a diagram illustrating a cell that is formed according to an exemplary embodiment of the present invention, and FIG. 4 is a flowchart illustrating a method of configuring a cell according to another exemplary embodiment of the present invention.

An exemplary embodiment of FIGS. 3 and 4 illustrates a case where terminals to participate in communication by exceeding a 1-hop communication radius are scattered, i.e., multihop relay, and a hidden node problem should be considered.

First, the terminal 140 searches for an idle band (S410). If the found band is idle, the terminal 140 periodically broadcasts a previously promised preamble sequence (S420).

If a terminal having detected use of a corresponding band by other cells exists, a multimode terminal 150 having received a preamble transmits a collision indication sequence or a collision report (CLS-REP) message to the terminal 140 (S430). In this case, the CLS-REP message includes collision information. An information field that is included in the CLS-REP may include an RSSI level, detailed information of a detected cell, for example, information on whether interference is formed by infra mode communication, by direct communication, or by a multimode terminal. When it can be distinguished that a cell that is detected at this time is a trunked mode operation (TMO), direct mode operation (DMO), or a cell formed by a multimode terminal, by distinguishing the cell, a collision indication sequence or a CLS-REP message can be transmitted.

When the terminal 140 receives a collision indication sequence or a CLS-REP message (CLS-REQ), the terminal 140 recognizes a corresponding band as a busy state, searches for another frequency, and repeats a previous process.

If the terminal 140 does not receive a collision indication sequence or a CLS-REP message, the terminal 140 transmits a downlink frame including broadcasting information and a map (S440).

The terminal 140 transmits a preamble for searching out interference at a hidden node, a 2-hop node, or a 2-hop position to multimode terminals 150 at 1 hop and allocates an uplink resource for a terminal of a hidden node, i.e., 2 hops or more, to the multimode terminals 150 (S450). Thereafter, the terminal 150 transmits a preamble to a terminal 160, i.e., a 2-hop terminal (S460).

When a terminal that detects use of a corresponding band by the other cell exists, the terminal 160, having received a preamble for searching out a hidden node from the terminal 150, transmits a collision indication sequence or a collision report message (CLS-REQ) to the terminal 150 (S470). In this case, in order to notify other adjacent terminals that a state of a corresponding band is confused, the terminal 150 transmits a collision indication sequence and then performs steps S410, S420, and S430. However, when the terminal 160, having determined that a corresponding band is idle, wants to participate to communication, the terminal 160 transmits a CDMA ranging code to a corresponding transmission position and notifies existence thereof (S490).

The terminal 150, having received a collision indication sequence or a CLS-REQ transfers the collision indication sequence or the CLS-REQ to the terminal 140 (S480). When receiving the collision indication sequence or the CLS-REQ, the terminal 140 recognizes a corresponding band as a confusion state and again performs steps S410, S420, and S430. If the terminal 140 does not receive a collision indication sequence or a CLS-REQ for a predetermined time period, the terminal 140 performs a network entry procedure with neighbor terminals 150 (S491). The terminal 150 notifies the terminal 140 that a collision does not occur in a corresponding band, and transmits ranging code information, for example, a ranging code index, a receiving frame index, and a CINR level that are received after a network entry procedure is complete, to the terminal 140 (S492).

Thereafter, the terminal 140 determines a relay terminal based on ranging code information of a terminal 160 (S493).

Hereinafter, a method of optimizing a cell according to another exemplary embodiment of the present invention will be described.

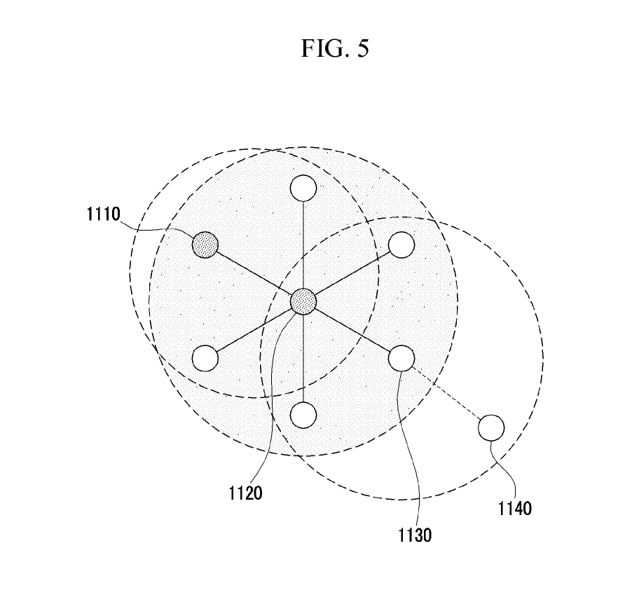

FIG. 5 is a diagram illustrating an example of an optimized cell by a method of optimizing a cell according to another exemplary embodiment of the present invention. In FIG. 5, the terminal is a general function terminal or a multimode terminal that can operate as a BS or a relay station according to a case.

In FIG. 5, all terminals 1110, 1120, 1130, and 1140 use a single frequency and have a list of 1-hop terminals thereof. The terminals 1110, 1120, and 1130 each have a communication radius. Further, for a cell optimization configuration, direct mode operation (DMO) or existing multimode operation (MMO) may be used.

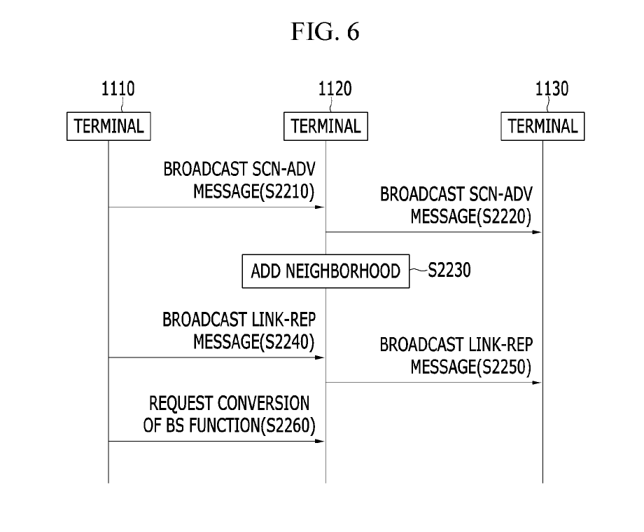

FIG. 6 is a flowchart illustrating a method of optimizing a cell according to another exemplary embodiment of the present invention. Referring to FIG. 6, after the terminal 1110 firstly finds a 1-hop user thereof, i.e., the terminal 1120, the terminal 1110 broadcasts a scanning broadcasting message (SCN-ADV message) (S2210). When an existing MMO is operating, the terminal 1110 that performs a function of a BS starts such a step. In this case, the SCN-ADV message includes a neighbor list, transmission power of a message, power capability thereof, for example, maximum power, a battery level, and an SCN-ADV message transmission interval.

Thereafter, the terminal 1120, having received the SCN-ADV message, transmits the SCN-ADV message again according to the order of a neighbor list of the SCN-ADV messages (S2220).

In this case, when a communication link of the DMO is used, if all neighbor terminals within an SCN-ADV message of the previous terminal 1110 are in a relationship within a maximum of 2 hops, a corresponding terminal adds a new neighbor terminal to the SCN-ADV message (S2230). That is, an MMO cell is limited as 2-hop.

When using a communication link of TMO, a terminal that performs a function of a relay station can add lower terminals thereof to an SCN-ADV message as a new neighbor terminal.

Terminals that are not in a transmission sequence thereof receive an SCN-ADV message and measure a quality of a corresponding link.

Thereafter, when transmission of all neighbor lists is complete within an SCN-ADV message, the terminal 1110 broadcasts a link response message (LINK-REP) message (S2240). The LINK-REP message includes a role grade thereof and the link hole number, i.e., the relay link number and a neighbor list. Here, for a role grade, a grade calculation function in consideration of a link quality and a power level may be necessary.

Thereafter, terminals 1120, having received a LINK-REP message according to the order of a neighbor list that is included in the LINK-REP message, broadcast the LINK-REP message (S2250).

As a result, a terminal having a highest role grade performs a function of a BS. That is, a terminal X requests a conversion of a BS function to a corresponding terminal (S2260).

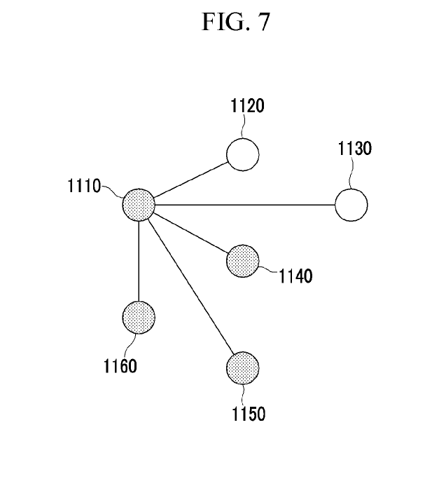

Hereinafter, a method of optimizing a cell according to another exemplary embodiment of the present invention will be described in detail with reference to FIGS. 7 to 9.

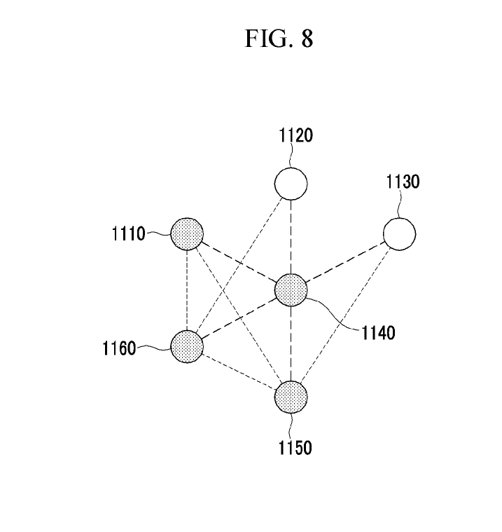

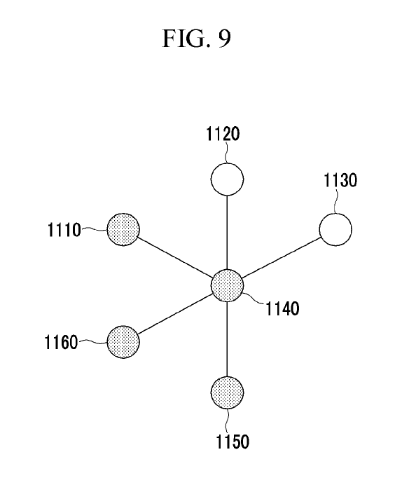

FIG. 7 is a diagram illustrating a method of configuring a cell according to another exemplary embodiment of the present invention, FIG. 8 is a diagram illustrating a link test procedure of a candidate terminal according to another exemplary embodiment of the present invention, and FIG. 9 is a diagram illustrating a method of converting a BS mode function according to another exemplary embodiment of the present invention.

The method of optimizing a cell of FIG. 7 relates to a method of selecting the most optimum BS mode operation terminal when a plurality of multimode terminals exist in a cell. Such a dynamic role change method may be initially performed when operating a cell, or may be performed periodically or at a necessary time point.

The multimode terminal 1110 while operating in a BS mode broadcasts a dynamic link test request (DLT-REQ) message to all terminals. A candidate terminal list may be included in the DLT-REQ message. The candidate terminal list can select only multimode terminals having a high BS mode operation possibility of a 1-hop lower terminal list of the terminal 1110 operating in a presently BS mode. In this case, a selection reference may be providing of functions for a BS mode and the remaining battery lifetime of a multimode terminal.

Further, a DLT-REQ message may include LTS transmission power and LTS transmission scheduling information. In this case, LTS transmission scheduling information may include a resource allocation size, a resource allocation period, and a resource allocation start frame index as a downlink fixing radio resource that is allocated in order to transmit an LTS of a candidate terminal that can operate in a BS mode. Candidate terminals transmit an LTS at a fixing radio resource position corresponding to a sequence thereof.

Further, the DLT-REQ message is to select a terminal that transmits a DLT-REP message such as a report reference of the DLT-REP message, for example, a threshold of a carrier to interference and noise ratio (CINR) and CINR deviation. For example, when a candidate terminal exists, which is a specific CINR level or more as an LTS CINR measurement result of candidate terminals, i.e., when distribution of an LTS CINR measurement result of candidate terminals in which a link state is a specific level or more is scattered, a measurement result of a corresponding terminal is reported.

Thereafter, each of the terminals 1110-1160 transmits an LTS with transmission power that is determined in a downlink frame of an allocated position according to the order of a candidate terminal list that is included in the DLT-REQ message, as shown in FIG. 8. All remaining terminals that do not transmit an LTS measure a CINR of the LTS at a corresponding frame position.

Thereafter, terminals satisfying a report reference of the DLT-REP message report a measurement result to the terminal 1110 through an uplink.

If a change of a BS mode operation terminal is necessary, the terminal 1110, having received a report of the result, requests a BS mode change together with a BS mode function negotiation to a corresponding multimode terminal 1140. If a battery lifetime of the terminal 1140 and providing of a BS mode function are available, the terminal 1140 accepts this and performs a function of a BS, as shown in FIG. 9. In this case, the terminal 1110 transfers connection setting information, traffic setting information, and encryption information of lower terminals 1120, 1130, 1150, and 1160 to a new BS mode terminal 1140, and induces group handover to the terminal 1140 to the lower terminals 1120, 1130, 1150, and 1160.

According to the present invention, in a communication system, a terminal performs a function of a BS and forms a cell and thus even in an emergency situation, a communication operation can be smoothly performed.

Further, according to the present invention, in a communication system, as a terminal performs a function of a BS and forms a cell, the cell is optimized and thus a method of performing a smooth communication operation can be provided.

While this invention has been described in connection with what is presently considered to be practical exemplary embodiments, it is to be understood that the invention is not limited to the disclosed embodiments, but, on the contrary, is intended to cover various modifications and equivalent arrangements included within the spirit and scope of the appended claims.

What is claimed is:

1. A method of optimizing a cell by a multimode terminal, the method comprising:
broadcasting, by a first terminal, a scanning broadcasting message to a second terminal;
broadcasting, by the first terminal, a link response message to the second terminal; and
performing, by a terminal having a highest role grade of a base station (BS), a function of the BS according to a request of the BS.

2. The method of claim 1, wherein the scanning broadcasting message comprises power capability of the first terminal.

3. The method of claim 2, wherein the scanning broadcasting message comprises a battery level of the first terminal.

4. The method of claim 1, wherein the link response message comprises a BS role grade of the first terminal.

5. A method of optimizing a cell by a multimode terminal, the method comprising:
broadcasting, by the multimode terminal that is operated in a BS mode, a dynamic link test request message comprising a candidate terminal list to other terminals;
receiving a link test sequence (LTS) from the other terminals according to the order of the candidate terminal list; and
requesting, by the multimode terminal, if a change of a BS mode operation terminal is necessary, a BS mode change to the selected terminal.

6. The method of claim 5, wherein the dynamic link test request message comprises transmission power information of the LTS.

7. The method of claim 5, further comprising inducing, by the multimode terminal, handover to the selected terminal to other terminals.

8. A method of configuring a cell of a terminal, the method comprising:
transmitting, by the terminal, when the terminal searches for an idle band, a downlink frame;
performing a network entry procedure with other terminals at 1 hop from the terminal; and
optimizing, by the terminal, transmission power.

9. The method of claim 8, wherein the idle band is determined as idle when the idle band does not exceed a received signal strength indication (RSSI) threshold.

10. The method of claim 8, wherein the terminal is a multimode terminal that can operate as a BS or a relay station.

11. A method of configuring a cell of a terminal, the method comprising:
searching for, by a first terminal, a band and periodically broadcasting, if the band is determined as idle, a preamble;
receiving a collision report message from a second terminal having received the preamble; and
recognizing, by the first terminal, the band as a confusion state and searching for another band.

12. The method of claim 11, wherein the second terminal is positioned at 1-hop from the first terminal.

13. A method of configuring a cell of a terminal, the method comprising:
searching for, by a first terminal, a band and periodically broadcasting, if the band is determined as idle, a preamble;
transmitting, if the first terminal does not receive a collision report message from another terminal, a downlink frame to a second terminal;
allocating an uplink resource for a third terminal to the second terminal;
receiving a collision report message of the third terminal from the second terminal; and
recognizing, by the first terminal, the band as a confusion state and searching for another band.

14. The method of claim 13, wherein the second terminal is positioned at 1 hop from the first terminal, and the third terminal is positioned at 2 hops from the first terminal

15. A method of configuring a cell of a terminal, the method comprising:
searching for, by a first terminal, a band and periodically broadcasting, if the band is determined as idle, a preamble;
transmitting, if the first terminal does not receive a collision report message from another terminal, a downlink frame to a second terminal;
allocating an uplink resource for a third terminal to the second terminal; and
performing, if a collision report message of the third terminal is not received from the second terminal for a predetermined time period, a network entry procedure with the second terminal or the third terminal.

16. The method of claim 15, further comprising determining, when a network entry procedure is performed, a relay terminal based on a received ranging code.

17. The method of claim 15, wherein the second terminal is positioned at 1 hop from the first terminal, and the third terminal is positioned at 2 hops from the first terminal.
